(19) United States
(12) Patent Application Publication
(10) Pub. No.: US 2021/0198500 A1
(43) Pub. Date: Jul. 1, 2021

(54) Aromatic Amide Dispersant

(71) Applicant: Lubrizol Advanced Materials, Inc., Cleveland, OH (US)

(72) Inventors: Andrew J. Shooter, Wilmslow (GB); Shabana Rafiq, Manchester (GB); Conor Wilkinson, Manchester (GB)

(21) Appl. No.: 17/269,808

(22) PCT Filed: Aug. 21, 2019
(86) PCT No.: PCT/US2019/047446

§ 371 Date: Feb. 19, 2021

Related U.S. Application Data
(60) Provisional application No. 62/721,333, filed on Aug. 22, 2018.

(51) Int. Cl. C09D 7/45; C08G 81/02; C09D 7/65; C09D 17/00; C09D 11/037; C09D 11/033

(52) U.S. Cl. CPC C09D 7/45; C08G 81/025; C09D 7/65; C09D 11/033; C09D 17/001; C09D 17/002; C09D 11/037; C09D 17/008

(57) ABSTRACT

The present invention relates to a polymeric dispersant containing an tertiary amide linkage between the aromatic anchoring group and a solubilizing chain, and a composition containing a particulate solid, an aqueous or polar organic medium, and a polymeric aromatic amide dispersant having at least one tertiary amide linking group connecting through a carbonyl group of the amide to an aromatic ring having two or more residual carboxylic acid groups or a sulfonic acid group and a residual carboxylic acidic group thereon. The invention further provides compositions for millbases, dispersions, coatings and inks containing said dispersant.

### FIELD OF INVENTION

The present invention relates to a polymeric aromatic amide dispersant, and a composition containing a particulate solid, an aqueous medium or polar organic medium, and a polymeric dispersant having an aromatic ring with acid functionality chemically linked via a tertiary amide linkage to a solubilizing polymer chain. The invention further provides compositions for millbases, dispersions, coatings (including paints) and inks containing said dispersant.

### BACKGROUND OF THE INVENTION

Many formulations such as inks, paints and millbases require effective dispersants for uniformly distributing a particulate solid in an aqueous or polar organic medium. For inks, it is desirable for ink manufacturers to generate printed products of high resolution and quality. The adaptability of a printing process to cater for the ever-widening range of base substrates, resins and pigments is a challenge. The pigment dispersion should be compatible with the different formulations used to ensure good adhesion and resistance of the final coating. Poor pigment dispersion or stabilization can result in agglomeration or settling within the polar organic liquid medium or an aqueous liquid medium.

PCT Patent Publication WO 2008/028954 discloses imide dispersant compounds containing terminal acidic groups in both a polar and a non-polar organic medium, where the dispersant compound is represented by the structure:

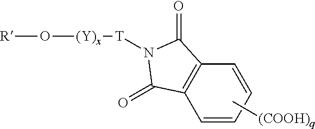

where T is —(CH₂)₃- or —CH₂CH(CH₃)—;

R′ is H or C₁₋₅₀-optionally substituted hydrocarbyl group or C₁₋₅₀-optionally substituted hydrocarbonyl;

Y is C₂₋₄-alkyleneoxy;

x is 2 to 90; and

q is 1 or 2.

U.S. Pat. No. 5,688,312 discloses an ink composition comprised of a colorant and an imide or bisimide with a viscosity from about 1 centipoise to 10 centipoise at a temperature of about 125 to 180° C. The imide or bisimide may be prepared by reacting phthalic anhydride and a mono- or di-amine. The monoamine may be, for example, dodecylamine or stearylamine. The diamine may be 1, 12-dodecanediamine.

PCT Patent Publication WO 2007/139980 discloses a reaction product of at least one di-anhydride with at least two reactants which are different from each other, each of which reactants contains a primary or secondary amino, hydroxyl or thiol functional group, and at least one of which reactants is polymeric. The reaction product is useful in compositions such as inks and coatings.

U.S. Pat. No. 6,440,207 discloses a process for preparing dispersible dry organic pigments for aqueous systems by (a) milling a mixture containing (1) one or more organic pigments, (2) at least about 1% by weight, relative to the organic pigment, of one or more aromatic poly(alkylene oxide) dispersants, (3) 0 to about 10 parts by weight, relative to the organic pigment, of a milling liquid in which the organic pigment is substantially insoluble, (4) 0 to about 50% by weight, relative to the organic pigment, of one or more milling additives other than dispersant (2), and (5) 0 to about 20% by weight, relative to the organic pigment, of one or more surface treatment additives; (b) optionally, adding to the milled pigment (6) one or more liquids in which the organic pigment is substantially insoluble in amounts such that the total solids content is not reduced below about 10%, and (7) one or more multivalent metal salts and/or one or more quaternary ammonium salt; and (c) isolating the milled organic pigment. The aromatic poly(alkylene oxide) dispersant may be prepared by reacting in an autoclave containing 250 g of deionized water 19.8 g (0.100 mol) of 1,8-naphthalic anhydride and 105 g (0.105 mol) of Jeffamine™ XTJ-506 (83 wt % ethylene oxide, 17 wt % propylene oxide). The autoclave was sealed, heated with stirring to 150° C., and maintained at 150° C. for five hours. After the reaction had cooled, the resultant brown liquid was discharged into a beaker to which was then added 15 g of decolorizing charcoal. After stirring overnight, the suspension was filtered, and the filter cake washed with water, yielding approximately 500 g of an amber-colored filtrate having 23.63% solids content. The dry pigment can be employed in water-based paint systems.

US Patent Publication 2008/0202382 describes the use of a Michael reaction of a poly ether methacrylate and a polyamine for the dispersion of ultrafine particles. The invention relates to amine dispersants for organic dispersions and coating compositions that contain such dispersants.

US Patent Publication 2015/112020 describes the use of a fused aromatic imide pendant group as an anchor for pigment dispersants represented by the structure:

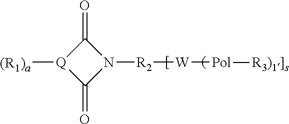

where R₁ is a substituent on Q ring in any available position for bonding to a substituent and independently represented by at least one electron withdrawing group, a is 1 or two. W is oxygen, sulfur, NH or NG. R₂ is a C₁₋₂₀ hydrocarbylene group or a C₁₋₂₀ hydrocarbonylene group where R₂ contains more than 2 carbon atoms and can be linear or branched. R₃ is H or C₁₋₅₀ optionally substituted hydrocarbyl group bonding to a terminal oxygen atom of the polymer chain forming a terminal ether or ester. Pol is a homopolymer chain of ethylene oxide or a copolymer chain of ethylene oxide wherein the ethylene oxide constitutes 40 wt % to 99.99 wt % of the copolymer chain consisting of polyether or polyester.

### SUMMARY OF THE INVENTION

One objective of the present invention is to provide a dispersant capable of giving low viscosity colloidally stable dispersions with inorganic and organic pigments. By providing more colloidal stability one can improve color strength, other tinctorial properties, increasing a particulate solid load, forming improved dispersions, having improved brightness, producing a composition with reduced viscosity, maintain stable dispersion, reduced particle size and reduced particle size distribution, reduce haze, improve gloss, improve color strength and increase jetness (especially when the composition includes inorganic pigment or filler). The composition of the present invention may also be colloidally stable under ambient storage, and high temperature storage conditions.

We recently discovered that first reacting a primary amine terminated solubilizing chain, such as a polyether amine with an acrylate then an anhydride of an acid functionalized aromatic dicarboxylic or polycarboxylic acid is advantageous as only an amide (and not an imide) can be formed. The resulting free carboxyl group on the aromatic ring significantly enhances dispersion performance on inorganic pigments in addition to organic and carbon black pigments.

Aromatic Amide Functional Dispersants

A dispersant comprising a dispersant polymer having the following structure:

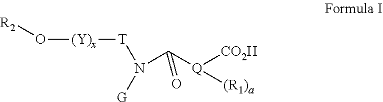

R₁ is independently CO₂H or SO₃H where a is 1 to 2 or 3;

R₂ is H or C₁₋₅₀ optionally substituted hydrocarbyl or C₁₋₅₀ optionally substituted hydrocarbonyl group;

G is a C₁₋₅₀ hydrocarbyl group optionally substituted with heteroatoms such as O or N represented as ether, ester, aldehyde, ketone, amide, urethane, alcohol or carboxylic acid groups, or the residue (expected reaction and/or polymerization product of a chemical reaction of the named reactive species) of an optionally substituted alkyl (meth)acrylate or (meth)acrylamide, or the ring opening product of an epoxide of the formula

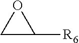

wherein R₆ can individually on each occurrence be H or CH₃ or C₂H₅ or one of the following groups:

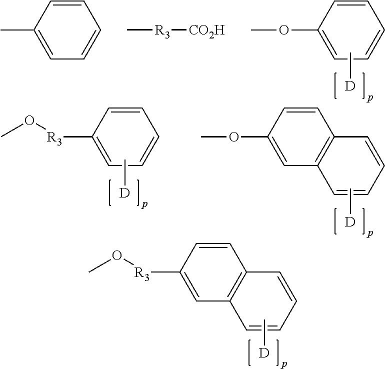

wherein D is C₁₋₅ alkyl group, CN, OH, NO₂, NH₂, halogen, CO₂H, SO₃H, CH₃ or OCH₃; and p is from 0 to 4;

R₃ is a linear or branched C₁₋₅₀ and preferably C₁₋₂₀ alkyl group;

wherein T is —C(O)—CH(R₄)CH₂ or C₁₋₅ hydrocarbyl chain;

when G is C₁₋₅₀ hydrocarbyl, T is —C(O)—CH(R₄)CH₂,

when G is residue (expected reaction and/or polymerization product of a chemical reaction of the named reactive species) of acrylate or epoxide, T is C₁₋₅ hydrocarbyl chain;

R₄ is H or Me, preferably H;

Y independently in each repeat unit is C₂-4 alkyleneoxy;

Q is a hydrocarbylene group comprising one or more aromatic ring, substituted with R₁, (up to three or four rings), optionally being fused if two aromatic rings are present, wherein carboxylic acid group attached to Q are attached to a carbon atom of the aromatic ring of Q;

wherein the hydrogen of any acid in the formula can be replaced by a metal, amine, or ammonium cation to place the dispersant in the form of a salt; and

x is 2 to 90.

In one embodiment, Q may be based on a benzene ring with amide linkage. In one preferred embodiment, Q is derived from 1,2,4-benzene tricarboxylic anhydride. The carboxylic acid or sulphonic groups attached to Q are attached to an aromatic ring carbon of Q.

### DETAILED DESCRIPTION OF THE INVENTION

The present invention provides a dispersant and a composition comprising said dispersant, a particulate solid (such as a pigment or filler) and an aqueous or polar organic media and uses of said particulates, dispersants, and continuous media as mill bases, inks, coatings (paint), etc. If used as a coating, the composition can optionally include a binder.

The polymer chain may have number average molecular weight of 100 to 10,000, or 100 to 5,000, or 300 to 3,000, or 400 to 2,500.

The number average molecular weight may be determined for a pre-prepared polymer chain by GPC analysis. The number average molecular weight of a polymer that is prepared in-situ i.e., the polymer chain is grown off the initiating species (initiator) group may be calculated by determining the degree of polymerisation (DP) which is proportional to the ratio of monomer [M] and initiator [I] (the initiator being the fused aromatic anhydride derived intermediate), and calculated by the formula DP=[M]/[I]. Analysis using nuclear magnetic resonance (NMR) can be used to determine the degree of polymerization and thus to calculate number average molecular weight of the polymeric group or polymer segment of the molecule.

Definition of hydrocarbyl and hydrocarbylene group. As used herein, the term “hydrocarbylene” is used in the ordinary sense of the term and is intended to include any divalent radical formed by removing two hydrogen atoms from a hydrocarbon. The terms “hydrocarbyl” or “hydrocarbylene” denotes a group having a carbon atom directly attached to the remainder of the molecule and having a hydrocarbon or predominantly hydrocarbon character within the context of this invention. Such groups include the following: (1) Purely hydrocarbon groups; that is, aliphatic, (e.g., alkyl or alkenyl), alicyclic (e.g., cycloalkyl or cycloalkenyl), aromatic, aliphatic- and alicyclic-substituted aromatic, aromatic-substituted aliphatic and alicyclic groups, and the like, as well as cyclic groups wherein the ring is completed through another portion of the molecule (that is, any two indicated substituents may together form an alicyclic group). Examples include methyl, ethyl, octyl, decyl, octadecyl, cyclohexyl, phenyl, etc. (2) Substituted hydrocarbon groups; that is, groups containing non-hydrocarbon substituents which do not alter the predominantly hydrocarbon character of the group. Those skilled in the art will be aware of suitable substituents. Examples include hydroxy, nitro, cyano, alkoxy, acyl, etc. (3) Hetero groups; that is, groups which, while predominantly hydrocarbon in character, contain atoms other than carbon and hydrogen in a chain or ring otherwise composed of carbon atoms. Suitable hetero atoms will be apparent to those skilled in the art and include, for example, nitrogen, oxygen and Sulphur.

As used herein, the term “hydrocarbocarbylene” is intended to include any hydrocarbon group containing a carbonyl group (>C═O), e.g., a hydrocarbon group containing a ketone group or an aldehyde group. Typically, a hydrocarbonylene group may include —(CH₂)₅—C(O)—, —(CH₂)₄—C(O)—, —(CH₂)₃—C(O)— or —(CH₂)₂—C(O)—. As used herein, reference to hydrocarbylene or hydrocarbonylene groups may be linear or branched, and saturated or unsaturated.

A dispersant is disclosed comprising a dispersant polymer having the following structure:

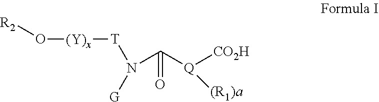

R₁ is independently CO₂H or SO₃H where a is 1 to 2 or 3;

R₂ is H or C₁₋₅₀ optionally substituted hydrocarbyl or C₁₋₅₀ optionally substituted hydrocarbonyl group;

G is a C₁₋₅₀ hydrocarbyl group optionally substituted with heteroatoms such as O or N presented as/represented as ether, ester, aldehyde, ketone, amide, urethane, alcohol or carboxylic acid groups, or the residue (expected reaction and/or polymerization product of a chemical reaction of the named reactive species) of an optionally substituted alkyl (meth)acrylate or (meth)acrylamide, or ring opening product of an epoxide of the formula

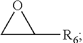

wherein R₆ can individually on each occurrence be H or CH₃ or C₂H₅ or one of the following groups:

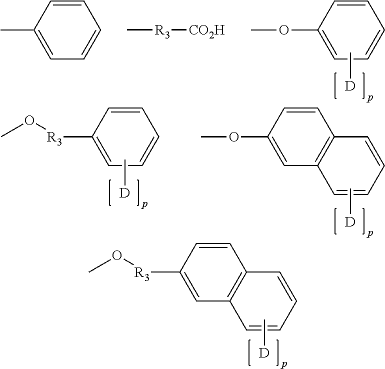

wherein D is C₁₋₅ alkyl group, CN, OH, NO₂, NH₂, halogen, CO₂H, SO₃H, CH₃ or OCH₃; and p is from 0 to 4;

R₃ is a linear or branched C₁₋₅₀ and preferably C₁₋₂₀ alkyl group; T is —C(O)—CH(R₄)CH₂ or C₁₋₅ hydrocarbyl chain;

when G is C₁₋₅₀ hydrocarbyl, T is —C(O)—CH(R₄)CH₂,

when G is residue (expected reaction and/or polymerization product of a chemical reaction of the named reactive species) of acrylate or epoxide, T is C₁₋₅ hydrocarbyl chain;

R₄ is H or Me, preferably H;

Y independently in each repeat unit is C₂₋₄ alkyleneoxy;

Q is a hydrocarbylene group comprising one or more aromatic ring, substituted with R₁, (up to three or four rings), optionally being fused if two aromatic rings are present, wherein carboxylic acid group attached to Q are attached to a carbon atom of the aromatic ring of Q;

wherein the hydrogen of any acid in the formula can be replaced by a metal, amine or ammonium cation to place the dispersant in the form of a salt; and

x is 2 to 90.

In one embodiment, Q may be based on a benzene ring with amide linkage. In one preferred embodiment, Q is a benzene ring derived from 1,2,4-benzene tricarboxylic anhydride. The carboxylic acid groups and optional sulfonic groups attached to Q are attached to carbon atoms of the aromatic ring of Q.

### Embodiment 1a

The reaction between polyether amine and (meth)acrylate

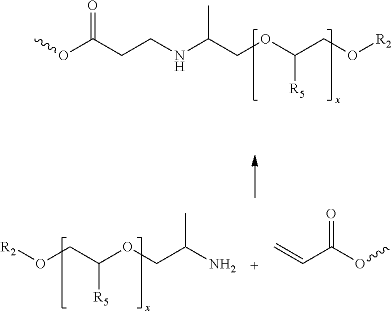

### Embodiment 2a

The reaction between polyether amine and epoxide

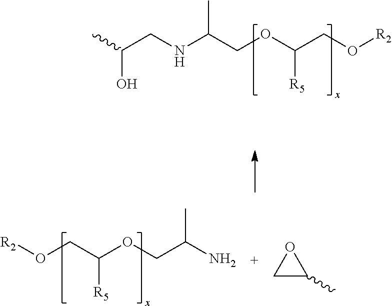

### Embodiment 3a

The reaction between alkyl amine and polyether (meth)acrylate

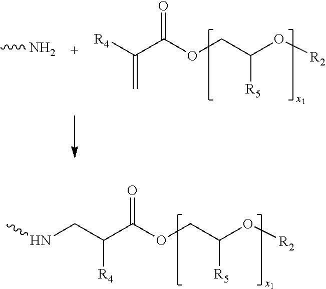

The following are structures for the units added to the nitrogen atom of the amide linkage before the nitrogen is reacted with a carboxylic group of the aromatic ring to form an amide linkage. The * represents the point of attachment of the shown structure to the nitrogen atom. These structures are derived from the unsaturated monomers shown farther down (such as the various acrylates).

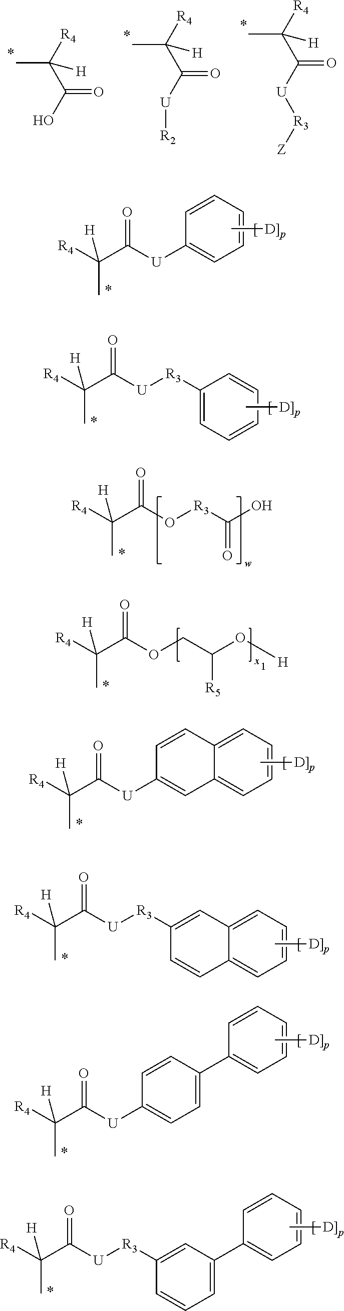

Z is —OH, —N(R₇)₂ (where R₇ individually at each occurrence is a C₁₋₅ alkyl group), C₃₋₆ cycloalkyl group, a 5, 6 or 7 atom heterocycle of carbon and oxygen and/or nitrogen; or acid group such as CO₂H, SO₃H, OPO₃H₂, U is O or NH, w is 1 to 20, preferably 1 to 10 and most preferably 1-5. D and p are as previously defined and xi is an integer from 1 to 50 and more desirably from 1 to 20. The value of 1 to 20 is preferred for w when the media for dispersing particulate is or contains large amounts of polar organic solvent. The value of 1 to 5 for w is preferred when the media for dispersing particulate is water.

Examples of monomers that would form G are as follows, where U is O or NH, R₂ is a is H or C₁₋₅₀ optionally substituted hydrocarbyl or C₁₋₅₀ optionally substituted hydrocarbonyl group, R₃ is a linear or branched C₁₋₅₀ and preferably C₁₋₂₀ alkyl group, R₄ is H or CH₃, R₅ is H or a methyl, ethyl, propyl, butyl or phenyl group and xi is 1 to 20. D is C₁₋₅ alkyl group, CN, OH, NO₂, NH₂, halogen, CO₂H, SO₃H, CH₃ and OCH₃ and p is from 0 to 4.

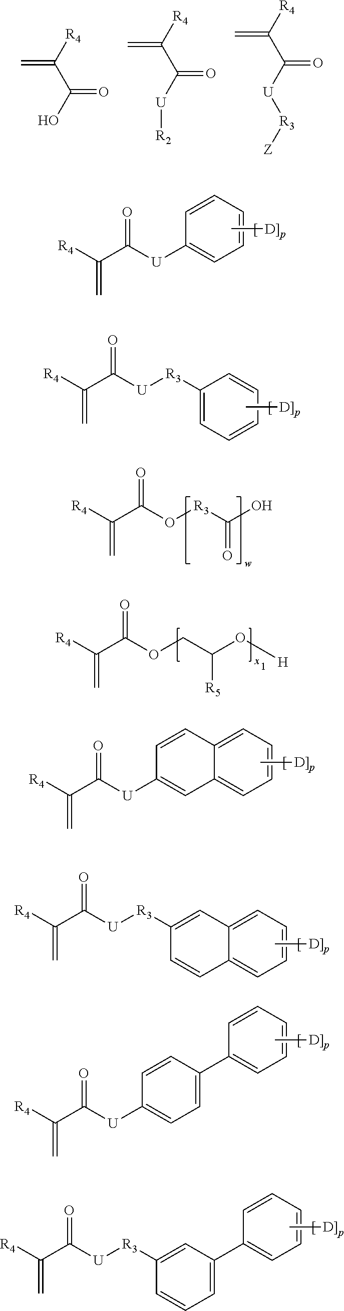

Example of an epoxide that would form G is as follows:

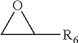

wherein R₆ can individually on each occurrence be H, CH₃ C₂H₅ or the following groups:

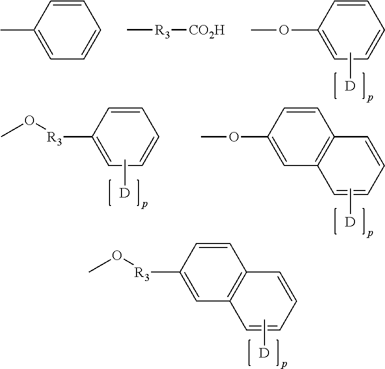

wherein D is C₁₋₅ alkyl group, CN, OH, NO₂, NH₂, halogen, CO₂H, SO₃H, CH₃ or OCH₃ and p is from 0 to 4

The dispersant can have the following structures:

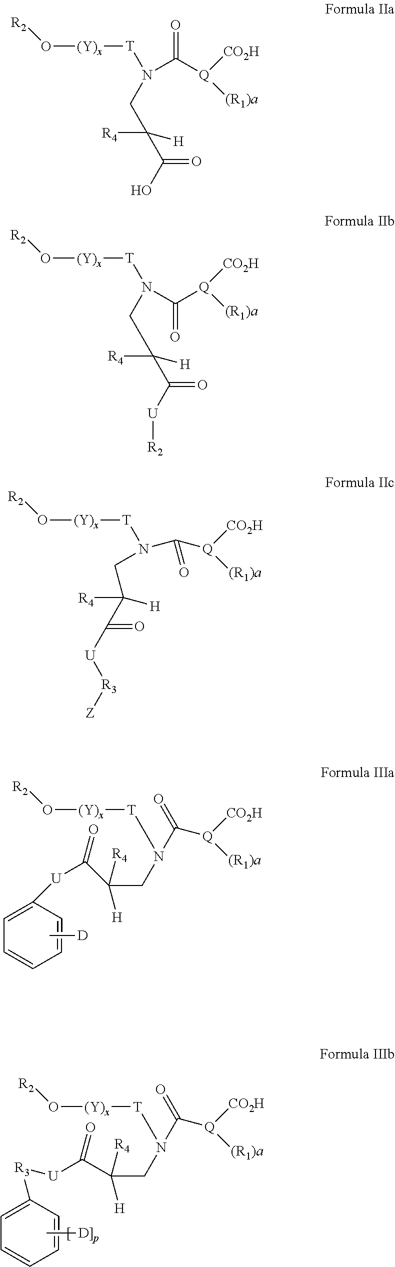

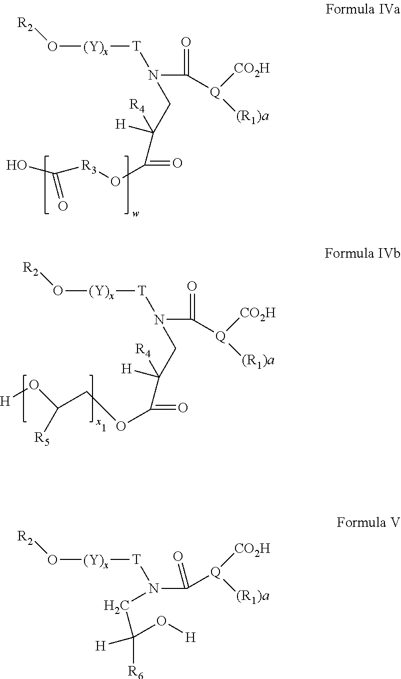

Where R₆ can be R₂, an optionally substituted benzene ring, a R₃—CO₂H group, an ether linkage to an optionally substituted benzene ring, or an ether linkage to an optionally substituted naphthalene fused aromatic ring structure.

Q is an organic structure having at least one and up to 3 or 4 aromatic rings (which may optionally be fused together) and may be based on a benzene, phenyl, biphenyl or fused aromatic ring such as naphthalene or anthracene. In one embodiment, Q may be a single benzene ring derived from benzoic acid. Typically, Q-(R₁)ₐ is derived from 1,2,4-benzene tricarboxylic acid anhydride.

Q may be based on a benzene, naphthalene, an anthracene, a phenanthrene or mixtures thereof. In one embodiment, Q may be based on a naphthalene. When Q is based on naphthalene, the polymer chain of Formula I may have a mono or poly R₁ substituted naphthalene amide group using positions on the naphthalene ring for the substitutents and amide linkage such as at least the 1,2; 2,3; or 1,8 positions on the naphthalene, or mixtures of such positions.

When Q is based on biphenyl, the polymer chain of Formula I may have a mono or poly R₁ substituted on the biphenyl rings using positions such as the 4′,3, 4; 5′,3,4; 3′,4′,3 or mixtures of such positions.

Examples anhydrides that would form Q are as follows where R₁ is CO₂H or SO₃H. Note R₁ may be present on any of the aromatic rings.

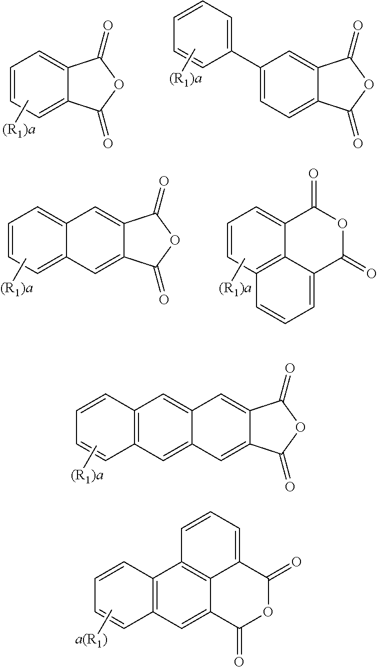

Typically, Q is derived from an aromatic tricarboxylic acid anhydride such as tricarboxylic naphthalene anhydride, a tricarboxylic biphenyl anhydride, a tricarboxylic benzene anhydride, or mixtures thereof.

Structure may be prepared by a process that comprises reacting a Michael acceptor, such as an (meth)acrylate or functionally substituted (meth)acrylate, with a nucleophilic polymeric chain, such as a polyether amine, forming a secondary amine and then reacting the secondary amine with an acid functionalized aromatic di-acid or anhydride, such as described above including tricarboxylic benzene anhydride and sulfonic acid functionalized dicarboxylic benzene anhydride, to form the tertiary amide and structure invention presented. The first step, the Michael reaction, may be carried out at a sufficiently high temperature for activation, e.g., 0° C. to 150° C. or 50° C. to 200° C. The second step of the reaction to form the tertiary amide is carried out at a sufficiently high temperature for amidation, e.g., at least 50° C. or 50° C. to 120° C.

Structure may be prepared by a process that comprises reacting a polymeric acrylate, such as MPEG acrylate, then reacting with a nucleophilic aliphatic amine forming a secondary amine and reacting the secondary amine with an acid functionalized aromatic di-acid or anhydride, such as tricarboxylic benzene anhydride, to form the tertiary amide and structure of the invention presented. The first step, the Michael reaction, may be carried out at a sufficiently high temperature for activation, e.g., 0° C. to 150° C. or 50° C. to 200° C. The second step of the reaction to form the tertiary amide is carried out at a sufficiently high temperature for amidation, e.g., at least 50° C. or 50° C. to 120° C.

Structure may be prepared by a process that comprises reacting a hydroxyl acrylate, such as hydroxyethyl acrylate, then reacting with a nucleophilic aliphatic amine forming a secondary amine and reacting the secondary amine with an acid functionalized aromatic di-acid or anhydride forming the tertiary amide. The product is then reacted with a cyclic ester, such as caprolactone, and polymerised to form the polymeric chain. The first step, the Michael reaction, may be carried out at a sufficiently high temperature for activation, e.g., 0° C. to 150° C. or 50° C. to 200° C. The second step of the reaction to form the tertiary amide is carried out at a sufficiently high temperature for amidation, e.g., at least 50° C. or 50° C. to 120° C. The polymerization may be carried out at a sufficiently high temperature for polymerization, e.g., at least 100° C. to 200° C.

### Embodiment 1—Aromatic Amide Functional Dispersant with Polyether Chains

In embodiment 1, a polyether amine is reacted with a (meth)acrylate (optionally substituted) via a Michael reaction to create a secondary amine and then the secondary amine is reacted with an acid functionalized aromatic anhydride. This is covered by Formulas IIa, IIb, IIc, Ma, IIIb, IVa, and IVb.

R₃ is C₁₋₅₀ (or C₁₋₂₀)-optionally substituted hydrocarbyl group that bonds to a terminal oxygen atom of the polymer chain forming a terminal ether or C₁₋₅₀ (or C₁₋₂₀)-hydrocarbonyl group (i.e., a hydrocarbyl group containing a carbonyl group) that bonds to the oxygen atom of the polymer chain forming a terminal ester group or terminal urethane group, and the substituent may be halo, ether, ester or mixtures thereof;

R₅ may be H or a mixture of H (in an amount sufficient to provide ethylene oxide groups at 40 wt % to 99.99 wt %) and at least one of methyl, ethyl and phenyl. The optionally substituted (meth)acrylates could be any of those shown below where the variables are as previously defined.

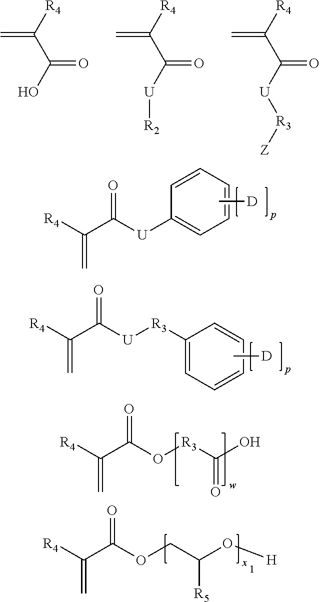

A reaction of a polyetheramine with (meth)acrylic acid then an acid functionalized aromatic anhydride, for example the reaction of Surfonamine® L207 with acrylic acid then tricarboxylic benzene anhydride. A reaction of a A reaction of a polyetheramine with a tertiary amino alkyl (meth)acrylate then an acid functionalized aromatic anhydride, for example the reaction of Surfonamine® L200 with dimethyaminoethyl acrylate then tricarboxylic benzene anhydride.

A reaction of a polyetheramine with an alkyl (meth)acrylate then an acid functionalized aromatic anhydride, for example the reaction of Surfonamine® L200 with butyl acrylate then tricarboxylic benzene anhydride.

The polyether may have number average molecular weight of 100 to 10,000, 100 to 5,000, or 300 to 3,000, or 400 to 2,500. The polyetheramine may be prepared by reacting a mono-alcohol initiator with ethylene oxide only or with a mixture of ethylene oxide and propylene oxide to form an alcohol-ended polymer chain, followed by conversion of the alcohol-ended polymer chain to an amine. The polyetheramine may be obtained by alkoxylation of aminoalcohols as is described in U.S. Pat. No. 5,879,445 (in particular the disclosure in column 2, line 50 to column 7, line 50).

For aqueous dispersions (50-100% water) the polyether may, for example, be a copolymer of ethylene oxide and propylene oxide. The polyether may be derived from:

0 to 60 wt % propylene oxide, and 40 to 100 wt % ethylene oxide, or

0 to 50 wt % propylene oxide, and 50 to 100 wt % ethylene oxide, or

0 to 30 wt % propylene oxide, and 70 to 100 wt % ethylene oxide, or

0 to 20 wt % propylene oxide, and 80 to 100 wt % ethylene oxide, or

0 to 15 wt % propylene oxide, and 85 to 100 wt % ethylene oxide.

The polyether amine may be commercially available as the Surfonamine® amines from Huntsman Corporation. Specific examples of Surfonamine® amines are L-100 (propylene oxide to ethylene oxide mix ratio of 3/19), and L-207 (propylene oxide to ethylene oxide mix ratio of 10/33), L-200 (propylene oxide to ethylene oxide mix ratio of (4/41), and L-300 (propylene oxide to ethylene oxide mix ratio of 8/58). The figures in parentheses are approximate repeat units of propylene oxide, and ethylene oxide respectively.

For polar organic media-based dispersions the polyether may be derived from:

0 to 60 wt % ethylene oxide, and 40 to 100 wt % propylene oxide, or 0 to 50 wt % ethylene oxide, and 50 to 100 wt % propylene oxide, or 0 to 30 wt % ethylene oxide, and 70 to 100 wt % propylene oxide, or 0 to 20 wt % ethylene oxide, and 80 to 100 wt % propylene oxide, or 0 to 15 wt % ethylene oxide, and 85 to 100 wt % propylene oxide.

### Embodiment 2—Aromatic Amide Functional Dispersant with Polyether Chain

In embodiment 2, a polyalkylene glycol (meth)acrylate is reacted with a primary amine then reacted with an acid functionalized aromatic anhydride. The primary amine reactant can be a polyether amine having a number-average molecular weight of 100 to 10000, more desirable 400 to 2500 containing alkylene oxide units such as ethylene oxide, propylene oxide, butylene oxide and styrene oxide; alternatively, the primary amine can be a lower molecular weight non-polymeric amine such as linear, branched, cyclic, and even aromatic containing hydrocarbyl or hydrocarbonyl group having 1 to 50, more desirable 1 to 20 carbon atoms and containing one or two (more desirably just one) primary amine and up to one or two secondary amines or other nitrogen containing groups such as amide linkages. Desirably the primary amine reactant can contain other heteroatoms such as oxygen and nitrogen (and optionally sulfur) in an amount of up to 4 heteroatoms each of oxygen, nitrogen and optionally sulfur per primary amine molecule. In one preferred embodiment the primary amine is polyether amine such as the previously discuss Surfonamine® polyether amines. In another preferred embodiment the primary amine is an alkyl amine without heteroatoms other than the nitrogen of the primary amine. In another preferred embodiment the primary amine is an amino carboxylic acid containing C₁₋₂₀ and may contain other heteroatoms such as oxygen and nitrogen (and optionally sulfur). In another preferred embodiment the primary amine is an amino alcohol containing C₁₋₂₀ and may contain other heteroatoms such as oxygen and nitrogen (and optionally sulfur). In another preferred embodiment the primary amine is an aromatic amine containing C₁₋₂₀ and may contain other heteroatoms such as oxygen and nitrogen (and optionally sulfur).

An example is the reaction of butyl amine with a poly(ethylene glycol) (meth)acrylate Mn 1000 followed by reaction with an acid functionalized aromatic anhydride.

### Embodiment 3—Aromatic Amide Functional Dispersant with Polyether Chains

In Embodiment 3, a polyalkyleneglycol(meth)acrylate is reacted with a polyether amine then reacted with an acid functionalized aromatic anhydride.

An example would be the reaction of Surfonamine® L100 with poly(ethylene glycol) acrylate Mn 350 then reaction with tricarboxylic benzene anhydride.

### Embodiment 4—Aromatic Amide Functional Dispersant with Polyester Chain

In Embodiment 4, a polyether amine is reacted with an epoxide (as previously defined) to create a secondary amine which is then reacted with an acid functionalized aromatic anhydride. An example would be the reaction of Surfonamine® L207 with 1,2-epoxy-3-phenoxypropane then reaction with tricarboxylic benzene anhydride.

In one embodiment, the invention provides a polymer comprising a polymer chain having at least one aromatic tertiary amide linking group attached to an aromatic group with a pendant acid functionality and a polyether group and a G group, wherein the polymer is represented by Formula I.

In one embodiment, the invention provides a polymer comprising a polymer chain having at least one aromatic tertiary amide linking group attached to an aromatic group with a pendant carboxylic acid functionality and a both a polyether group and a polyester group, wherein the polymer is represented by Formula I.

Examples of a lactones useful to polymerize the above polyester group include β-propiolactone, γ-butyrolactone, optional alkyl substituted ε-caprolactone and optionally alkyl substituted δ-valerolactone. The alkyl substituent in ε-caprolactone and δ-valerolactone may be C₁₋₆-alkyl, or C₁₋₄-alkyl, and may be linear or branched. Examples of suitable lactones are ε-caprolactone and the 7-methyl-, 2-methyl-, 3-methyl-, 5-methyl-, 6-methyl-, 4-methyl-, 5-tertbutyl-, 4,4,6-trimethyl- and 4,6,6-trimethyl-analogues of caprolactone or valerolactone.

The esterification catalyst may be any previously known to the art and include tin(II) octanoate, tetra-alkyl titanate, for example, tetrabutyltitanate, zinc salt of an organic acid, for example, zinc acetate, zirconium salt of an aliphatic alcohol, for example, zirconium isopropoxide, toluene sulphonic acid or a strong organic acid such as trifluoroacetic acid, or phosphoric acid.

The process may be carried out in an inert atmosphere provided by any inert gas of the Periodic Table but typically nitrogen. The process may be carried out in a melt, or in the presence or absence of solvent. The solvent may be a non-polar solvent (such as an aromatic or aliphatic compound), a polar organic solvent or water. The solvents are well known in the art.

In one embodiment, the polymer of the present invention (typically represented by Formula I may be obtained/obtainable by a process comprising Step (1): reacting a Michael acceptor, such as a (meth)acrylate or functionalized (meth)acrylate, with a nitrogen atom of a nucleophilic polymeric chain, such as a polyether amine, forming a polyether secondary amine; Step (2): reacting said polyether secondary amine with an acid functionalized aromatic di-acid or anhydride, such as tricarboxylic benzene anhydride, to form the tertiary amide connecting group between said aromatic acid and said polyether.

In the above embodiment, said first step can be conducted at a temperature from about 0° C. to 150° C., more desirably from about 30° C. to 80° C. and the second step of the reaction to form the tertiary amide can be carried out at a temperature from about 0° C. to 120° C., and more preferentially from about 30° C. to 80° C.

In one embodiment, the polymer of the present invention (typically represented by Formula I may be obtained/obtainable by a process comprising: Step (1): reacting a polymeric acrylate macromonomer having an unsaturated acrylate functionality, such as MPEG acrylate with a nucleophilic aliphatic amine forming a MPEG functionalized secondary amine; and

Step (2): reacting said MPEG functionalized secondary amine from Step (1) with an acid functionalized aromatic di-acid or anhydride, such as tricarboxylic benzene anhydride, to form the tertiary amide linkage from one of the acid groups of said diacid or anhydride, connecting said MPEG to said acid functionalized aromatic di-acid now an acid/amide, wherein said first step, the Michael reaction, may be carried out at a temperature from about 0° C. to 150° C., more desirably from about 30° C. to 80° C.; said second step of the reaction to form the tertiary amide is carried out at a temperature, for amidation, from about 0° C. to 120° C., and more desirably from about 30° C. to 80° C.

In one embodiment, the invention provides a composition comprising a particulate solid, an aqueous medium or polar organic medium, and a dispersant of Formula I having at least one tertiary amide pendant group, wherein the dispersant is represented by Formula I defined above. The composition may be a millbase, coating (paint), or ink.

In one embodiment, the invention provides a composition comprising a particulate solid, an aqueous medium or a polar organic medium, a dispersant according to Formula I, and a binder. In one embodiment, the binder may be polyepoxide, polyurethane, polyamide, poly(meth)acrylate, polyester, cellulose or alkyd.

In one embodiment, the invention provides a composition comprising a particulate solid, an aqueous medium or polar organic medium, and a dispersant having at least one tertiary amide linking group, wherein the dispersant is represented by Formula I above further comprises a binder. In one embodiment, the binder may be cellulose (such as nitrocellulose), polyurethane, poly(meth)acrylate, polyester, or polyamide.

The particulate solid disclosed herein in a composition of the present invention may be a pigment or a filler. The pigment may, in one embodiment, be an organic pigment, in one embodiment the pigment can be an inorganic pigment, and in one embodiment the pigment can be carbon black. In this disclosure, particulates of the inorganic type or carbon black are preferred.

In one embodiment, the invention provides a coating (paint) or ink comprising a particulate solid, an aqueous medium or a polar organic medium, a film-forming resin and a dispersant of the invention disclosed herein.

In one embodiment, the invention provides a coating (paint) or ink comprising a particulate solid, a polar organic medium, a film-forming resin and a dispersant of the invention disclosed herein.

When the composition is an ink, the ink may be an ink-jet ink, a flexo ink, offset ink or a gravure ink. The ink may be a radiation curable ink.

In one embodiment, the invention provides for a composition comprising a dispersant represented by Formula I defined above, an inorganic pigment (and/or carbon black) and a binder. The binder may be selected from the group consisting of cellulose, polyacrylic, polyester, polyether, polyurethane, alkyds and polyamide. The composition may be used in an ink for a printing process, such as a flexographic printing process or ink jet inks such as radiation curable, non impact and drop on demand.

The dispersant of the present invention may be present in a composition disclosed herein in an amount ranging from 0.1 wt % to 79.6 wt %, or 0.5 wt % to 30 wt %, or 1 wt % to 25 wt % of the total weight of the composition.

In one embodiment, the invention provides for the use of the dispersant polymer, wherein the dispersant polymer is represented by Formula I defined above as a dispersant in a composition disclosed herein.

In one embodiment, the invention provides for the use of a dispersant represented by Formula I defined above as a dispersant in an ink composition using at least one of carbon black and inorganic pigment. The ink composition may have at least one of reduced particle size and reduced particle size distribution (typically reduced to an average of 150 nm or less), reduced haze, improved gloss, increased jetness (especially when the composition is black) and be stable under ambient storage, and high temperature storage conditions.

Without being bound by theory, it is believed that the aromatic amide pendant group may act as an anchor group between the dispersant of invention and a particulate solid such as a pigment selected from inorganic pigment and/or carbon black.

The aminocarboxylic acid (or amino-acid) may be an amino-C₂₋₂₀-alk(en)ylene carboxylic acid and may or may not contain more than one carboxylic acid group and may or may not contain more than one amino group. The aminocarboxylic acid may or may not contain other groups containing heteroatoms such as hydroxyl or thiol groups. The alk(en)ylene group may be linear or branched. The alk(en)ylene group of the amino carboxylic acid contains not greater than 12 carbon atoms. Specific examples include 11-amino undecanoic acid, 12-amino dodecanoic acid, 6-amino caproic acid, 4-aminobutyric acid, aspartic acid, glutamic acid, lysine, asparagine, glutamine, threonine, serine, cysteine, β-alanine, glycine, and sarcosine. Mixtures of amino carboxylic acids may be used.

The technical feature defined within Q of 4n+2 π-electrons is well known to a skilled person as Hückel's rule. Typically, n may be equal to 2 (i.e., the number of it-electrons is 10), or 3 (i.e., the number of π-electrons is 14). In one embodiment, n may be equal to 2.

Typically, Q comprises one or more aromatic rings (optionally fused) derived from aromatic di or tetracarboxylic acid or their anhydrides, or mixtures thereof. R₁ is independently CO₂H or SO₃H where a may be 1 to 3.

R₂ may be an alkyl or optionally-substituted alkyl having an alkyl group that is linear or branched.

The alkyl groups defined by R₂ include methyl, ethyl, propyl, butyl, pentyl, hexyl, heptyl, 2-ethylhexyl, nonyl, decyl, undecyl, dodecyl, tridecyl, tetradecyl, pentadecyl, hexadecyl, heptadecyl, octadecyl, nonadecyl, eicosyl, or mixtures thereof. In one embodiment, R₂ may be derived from an alkanol.

R₃ may independently be a C₁₋₅₀, more desirably C₁₋₂₀ optionally substituted hydrocarbyl group such as an alkyl group.

The polyether amine may be commercially available as the Surfonamine® amines from Huntsman Corporation. Specific examples of Surfonamine® amines are L-100 (propylene oxide to ethylene oxide mix ratio of 3/19), and L-207 (propylene oxide to ethylene oxide mix ratio of 10/32), L-200 (propylene oxide to ethylene oxide mix ratio of 3/41), and L-300 (propylene oxide to ethylene oxide mix ratio of 8/58). The figures in parentheses are approximate repeat units of propylene oxide, and ethylene oxide respectively.

In Formula I, the integer x is such that the R₂—O—(Y)ₓ-T-N chain may have number average molecular weight of 100 to 10,000, or 100 to 5,000, or 300 to 3,000, or 400 to 2,500.

The reaction of the above is how to make the pendant polyether chain, with the oxirane in the processes described above may be carried out at a temperature of 100° C. to 200° C. in the presence of a base such as potassium hydroxide or sodium hydroxide.

In Formulas I and II, III, IV and IV and subsets thereof, a dispersant may be formed for a water rich organic medium wherein the polyether contains at least 60 wt % to 100 wt % ethylene oxide, alternatively an embodiment wherein the dispersant is formed for a polar organic medium wherein the polyether contains at least 40 wt % to 60 wt % ethylene oxide.

Typically, for an aqueous medium dispersant the (Y)x of Formula I contains 60 wt % to 100 wt %, 70 wt % to 100 wt %, or 80 wt % to 100 wt %, or 100 wt % ethylene oxide; and 0 wt % to 40 wt %, or 0 wt % to 30 wt %, or 0 wt % to 20 wt %, or 0 wt % propylene oxide based on the weight of (Y)x.

The polymer of the invention may have multiple polymer chain types attached to represented by Formula IVa, IVb.

The polymer chain of Formula I or any sub-formulas thereof may have a number average molecular weight of 200 to 10,000, or 300 to 5,000, or 500 to 3,000, or 600 to 2,500. Typically, the polymer chain of Formula I or any sub-formulas thereof may have number average molecular weight of 1,000 to 2,500.

### INDUSTRIAL APPLICATION

The particulate solid present in the composition may be any inorganic or organic solid material which is substantially insoluble in the organic medium and/or insoluble in water at the temperature concerned and which it is desired to stabilize in a finely divided form therein. The particulate solids may be in the form of a granular material, a fibre, a platelet or in the form of a powder, often a blown powder. In one embodiment, the particulate solid is a pigment.

The particulate solid (typically a pigment or filler) may have an average particle size measured by light scattering measurements of from 10 nanometers to 10 microns, or 10 nanometers to 1, 2, 3 or 5 microns, or 20 nanometers to 1, 2, 3 or 5 microns in diameter.

Examples of suitable solids are pigments, extenders, fillers, blowing agents and flame retardants for paints and plastic materials; dyes, especially disperse dyes; optical brightening agents and textile auxiliaries; pigments for inks, toners; solids for oil-based and inverse-emulsion drilling muds; dirt and solid particles in dry cleaning fluids; metals; particulate ceramic materials and magnetic materials for ceramics, piezoceramic printing, refactories, abrasives, foundry, capacitors, fuel cells, ferrofluids, conductive inks, magnetic recording media, water treatment and hydrocarbon soil remediation; organic and inorganic nanodisperse solids; metal, metal oxides and carbon for electrodes in batteries, fibers such as wood, paper, glass, steel, carbon and boron for composite materials; and biocides, agrochemicals and pharmaceuticals which are applied as dispersions in organic media.

In one embodiment, the solid is an organic pigment from any of the recognised classes of pigments described, for example, in the Third Edition of the Color Index (1971) and subsequent revisions of, and supplements thereto, under the chapter headed “Pigments.” Examples of organic pigments are those from the azo, disazo, trisazo, condensed azo, azo lakes, naphthol pigments, anthanthrone, anthrapyrimidine, anthraquinone, benzimidazolone, carbazole, diketopyrrolopyrrole, flavanthrone, indigoid pigments, indanthrone, isodibenzanthrone, isoindanthrone, isoindolinone, isoindoline, isoviolanthrone, metal complex pigments, oxazine, perylene, perinone, pyranthrone, pyrazoloquinazolone, quinacridone, quinophthalone, thioindigo, triarylcarbonium pigments, triphendioxazine, xanthene and phthalocyanine series, especially copper phthalocyanine and its nuclear halogenated derivatives, and also lakes of acid, basic and mordant dyes. Carbon black, although strictly inorganic, behaves more like an organic pigment in its dispersing properties. In one embodiment, the organic pigments are phthalocyanines, especially copper phthalocyanines, monoazos, disazos, indanthrones, anthranthrones, quinacridones, diketopyrrolopyrroles, perylenes and carbon blacks.

Examples of inorganic pigments include metallic oxides such as titanium dioxide, rutile titanium dioxide and surface coated titanium dioxide, titanium oxides of different colors such as yellow and black, iron oxides of different colors such as yellow, red, brown and black, zinc oxide, zirconium oxides, aluminium oxide, oxymetallic compounds such as bismuth vanadate, cobalt aluminate, cobalt stannate, cobalt zincate, zinc chromate and mixed metal oxides of two or more of manganese, nickel, titanium, chromium, antimony, magnesium, cobalt, iron or aluminium, Prussian blue, vermillion, ultramarine, zinc phosphate, zinc sulphide, molybdates and chromates of calcium and zinc, metal effect pigments such as aluminium flake, copper, and copper/zinc alloy, pearlescent flake such as lead carbonate and bismuth oxychloride.

Inorganic solids include extenders and fillers such as ground and precipitated calcium carbonate, calcium sulphate, calcium oxide, calcium oxalate, calcium phosphate, calcium phosphonate, barium sulphate, barium carbonate, magnesium oxide, magnesium hydroxide, natural magnesium hydroxide or brucite, precipitated magnesium hydroxide, magnesium carbonate, dolomite, aluminium trihydroxide, aluminium hydroperoxide or boehmite, calcium and magnesium silicates, aluminosilicates including nanoclays, kaolin, montmorillonites including bentonites, hectorites and saponites, ball clays including natural, synthetic and expandable, mica, talc including muscovites, phlogopites, lepidolites and chlorites, chalk, synthetic and precipitated silica, fumed silica, metal fibers and powders, zinc, aluminium, glass fibers, refractory fibers, carbon black including single- and multi-walled carbon nanotubes, reinforcing and non-reinforcing carbon black, graphite, Buckminsterfullerenes, asphaltene, graphene, diamond, alumina, quartz, perlite, pegmatite, silica gel, wood flour, wood flake including soft and hard woods, saw dust, powdered paper/fibre, cellulosic fibers such as kenaf, hemp, sisal, flax, cotton, cotton linters, jute, ramie, rice husk or hulls, raffia, typha reed, coconut fibre, coir, oil palm fibre, kapok, banana leaf, caro, curaua, henequen leaf, harakeke leaf, abaca, sugar cane bagasse, straw, bamboo strips, wheat flour, MDF and the like, vermiculite, zeolites, hydrotalcites, fly ash from power plants, icinerated sewage sludge ash, pozzolanes, blast furnace slag, asbestos, chrysotile, anthophylite, crocidolite, wollastonite, attapulgite and the like, particulate ceramic materials such as alumina, zirconia, titania, ceria, silicon nitride, aluminium nitride, boron nitride, silicon carbide, boron carbide, mixed silicon-aluminium nitrides and metal titanates; particulate magnetic materials such as the magnetic oxides of transition metals, often iron and chromium, e.g., gamma-Fe₂O₃, Fe₃O₄, and cobalt-doped iron oxides, ferrites, e.g., barium ferrites; and metal particles, for instance metallic aluminium, iron, nickel, cobalt, copper, silver, gold, palladium, and platinum and alloys thereof.

Other useful solid materials include flame retardants such as pentabromodiphenyl ether, octabromodiphenyl ether, decabromodiphenyl ether, hexabromocyclododecane, ammonium polyphosphate, melamine, melamine cyanurate, antimony oxide and borates; biocides or industrial microbial agents such as those mentioned in tables 2, 3, 4, 5, 6, 7, 8 and 9 of the chapter entitled “Industrial Microbial Agents” in Kirk-Othmer's Encyclopedia of Chemical Technology, Volume 13, 1981, 3^{rd} Edition, and agrochemicals such as the fungicides flutriafen, carbendazim, chlorothalonil and mancozeb.

In one embodiment, the polar liquid medium is water but may contain up to 50% by weight (based on the combined weight of the water and polar solvent) of a water-soluble polar co-solvent. Examples of such co-solvents that may qualify as polar solvents are alcohols such as ethyl alcohol, isopropyl alcohol, n-propyl alcohol or n-butanol; or water-miscible organic solvents such as mono or dialkyl ethers of ethylene glycol or diethylene glycol; or polar solvents such as diethylene glycol, glycerol, 2-pyrrolidone, N-methylpyrrolidone, cyclohexanol, caprolactone, caprolactam, pentane-1,5-diol, 2-(butoxyethoxy) ethanol and thiodiglycol, and ethylene glycol; including mixtures of any of the prior named alcohols or solvents. By the term “polar,” in relation to the organic liquid, it is meant that an organic liquid is capable of forming moderate to strong bonds as described in the article entitled “A Three Dimensional Approach to Solubility” by Crowley et al. in Journal of Paint Technology, Vol. 38, 1966, at page 269. Polar organic liquids generally have a dielectric constant of 5 or more as defined in the abovementioned article. Non-polar liquids typically have a dielectric constant of less than 5.

A millbase or dispersion is useful for the preparation of water-borne paints (coatings) and inks by admixture with further amounts of water-compatible resin(s) and/or water and other ingredients which are conventionally incorporated into water-borne paints and inks, such as preservatives, stabilizers, antifoaming agents, water miscible cosolvents and coalescing agents.

The water compatible resin may be any water-soluble or water insoluble polymer which is used in the water-borne coating industry. Examples of polymers which are commonly used as the principal film-forming binder resin in latex or water-reducible coatings are acrylic, vinyl ester, polyurethane, polyester, epoxy and alkyd.

The organic medium present in the composition of the invention, in one embodiment, is a plastics material and in another embodiment an organic liquid. The organic liquid may be a polar organic liquid. By the term “polar,” in relation to the organic liquid, it is meant that an organic liquid is capable of forming moderate to strong bonds as described in the article entitled “A Three Dimensional Approach to Solubility” by Crowley et al in Journal of Paint Technology, Vol. 38, 1966, at page 269. Such organic liquids generally have a hydrogen bonding number of 5 or more as defined in the abovementioned article.

Examples of suitable polar organic liquids are amines, ethers, especially lower alkyl ethers, organic acids, esters, ketones, glycols, glycol ethers, glycol esters, alcohols and amides. Numerous specific examples of such moderately strongly hydrogen bonding liquids are given in the book entitled “Compatibility and Solubility” by Ibert Mellan (published in 1968 by Noyes Development Corporation) in Table 2.14 on pages 39-40 and these liquids all fall within the scope of the term polar organic liquid as used herein.

In one embodiment, polar organic liquids are dialkyl ketones, alkyl esters of alkane carboxylic acids and alkanols, especially such liquids containing up to, and including, a total of 6 carbon atoms. As examples of the polar organic liquids include dialkyl and cycloalkyl ketones, such as acetone, methyl ethyl ketone, diethyl ketone, di-isopropyl ketone, methyl isobutyl ketone, di-isobutyl ketone, methyl isoamyl ketone, methyl n-amyl ketone and cyclohexanone; alkyl esters such as methyl acetate, ethyl acetate, isopropyl acetate, butyl acetate, ethyl formate, methyl propionate, methoxy propylacetate and ethyl butyrate; glycols and glycol esters and ethers, such as ethylene glycol, 2-ethoxyethanol, 3-methoxypropylpropanol, 3-ethoxypropylpropanol, 2-butoxyethyl acetate, 3-methoxypropyl acetate, 3-ethoxypropyl acetate and 2-ethoxyethyl acetate; alkanols such as methanol, ethanol, n-propanol, isopropanol, n-butanol and isobutanol (also known as 2-methylpropanol), terpineol and dialkyl and cyclic ethers such as diethyl ether and tetrahydrofuran. In one embodiment, solvents are alkanols, alkane carboxylic acids and esters of alkane carboxylic acids. In one embodiment, the present invention is suitable for organic liquids that are substantially non-soluble in an aqueous medium. Furthermore, a person skilled in the art will appreciate that small quantities of an aqueous medium (such as glycols, glycol ethers, glycol esters and alcohols) may be present in the organic liquids provided the overall organic liquid is substantially non-soluble in an aqueous medium.

Examples of organic liquids, which may be used as polar organic liquids are film-forming resins such as are suitable for the preparation of inks, paints and chips for use in various applications such as paints and inks. Examples of such resins include polyamides, such as Versamid™ and Wolfamid™, and cellulose ethers, such as ethyl cellulose and ethyl hydroxyethyl cellulose, nitrocellulose and cellulose acetate butyrate resins, including mixtures thereof. Examples of paint resins include short oil alkyd/melamine-formaldehyde, polyester/melamine-formaldehyde, thermosetting acrylic/melamine-formaldehyde, long oil alkyd, medium oil alkyd, short oil alkyd, polyether polyols and multi-media resins such as acrylic and urea/aldehyde.

The organic liquid may be a polyol, that is to say, an organic liquid with two or more hydroxy groups. In one embodiment, polyols include alpha-omega diols or alpha-omega diol ethoxylates.

In one embodiment, the organic liquid comprises at least 0.1% by weight, or 1% by weight or more of a polar organic liquid based on the total organic liquid. The organic liquid optionally further comprises water. In one embodiment, the organic liquid is free of water (typically less than 2 wt % water, or less than 1 wt % water, or less than 0.5 wt % water, or less than 0.1 wt %).

The plastics material may be a thermosetting resin. The thermosetting resins useful in this invention include resins which undergo a chemical reaction when heated, catalysed, or subject to ultra-violet, laser light, infra-red, cationic, electron beam, or microwave radiation and become relatively infusible. Typical reactions in thermosetting resins include oxidation of unsaturated double bonds, reactions involving epoxy/amine, epoxy/carbonyl, epoxy/hydroxyl, reaction of epoxy with a Lewis acid or Lewis base, polyisocyanate/hydroxy, amino resin/hydroxy moieties, free radical reactions or polyacrylate, cationic polymerization of epoxy resins and vinyl ether and condensation of silanol. Examples of unsaturated resins include polyester resins made by the reaction of one or more diacids or anhydrides with one or more diols. Such resins are commonly supplied as a mixture with a reactive monomer such as styrene or vinyltoluene and are often referred to as orthophthalic resins and isophthalic resins. Further examples include resins using dicyclopentadiene (DCPD) as a co-reactant in the polyester chain. Further examples also include the reaction products of bisphenol A diglycidyl ether with unsaturated carboxylic acids such as methacrylic acid, subsequently supplied as a solution in styrene, commonly referred to as vinyl ester resins.

In one embodiment, the thermosetting composite or thermosetting plastic may be a polyester, a polyvinyl acetate, a polyester resin in styrene, a polystyrene, or mixtures thereof.

Polymers with hydroxy functionality (frequently polyols) are widely used in thermosetting systems to crosslink with amino resins or polyisocyanates. The polyols include acrylic polyols, alkyd polyols, polyester polyols, polyether polyols and polyurethane polyols. Typical amino resins include melamine formaldehyde resins, benzoguanamine formaldehyde resins, urea formaldehyde resins and glycoluril formaldehyde resins. Polyisocyanates are resins with two or more isocyanate groups, including both monomeric aliphatic diisocyanates, monomeric aromatic diisocyanates and their polymers. Typical aliphatic diisocyanates include hexamethylene diisocyanate, isophorone diisocyanate and hydrogenated diphenylmethane diisocyanate. Typical aromatic isocyanates include toluene diisocyanates and biphenylmethane diisocyanates.

If desired, the compositions of the present invention may contain other ingredients, for example resins (where these do not already constitute the organic medium), binders, co-solvents, cross-linking agents, fluidising agents, wetting agents, anti-sedimentation agents, plasticizers, surfactants, dispersants other than the compound of the present invention, humectants, anti-foamers, anti-cratering agents, rheology modifiers, heat stabilizers, light stabilizers, UV absorbers, antioxidants, levelling agents, gloss modifiers, biocides and preservatives.

If desired, the compositions containing thermosetting plastic material may contain other ingredients, for example dispersants other than the compound of the present invention, blowing agents, flame retardants, process aids, surfactants, heat stabilizers, UV absorbers, anti-oxidants, fragrances, mould release aids, anti-static agents, anti-microbial agents, biocides, coupling agents, lubricants (external and internal), air release agents and viscosity depressants.

The compositions typically contain from 1 to 95% by weight of the particulate solid, the precise quantity depending on the nature of the solid and the quantity depending on the nature of the solid and the relative densities of the solid and the polar organic liquid. For example, a composition in which the solid is an organic material, such as an organic pigment, in one embodiment, contains from 15 to 60% by weight of the solid whereas a composition in which the solid is an inorganic material, such as an inorganic pigment, filler or extender, in one embodiment, contains from 40 to 90% by weight of the solid based on the total weight of composition.

The compositions containing an organic liquid may be prepared by any of the conventional methods known for preparing dispersions. Thus, the solid, the organic medium and the dispersant may be mixed in any order, the mixture then being subjected to a mechanical treatment to reduce the particles of the solid to an appropriate size, for example by high speed mixing, ball milling, basket milling, bead milling, gravel milling, sand grinding, attritor grinding, two roll or three roll milling, plastic milling until the dispersion is formed. Alternatively, the solid may be treated to reduce its particle size independently or in admixture with either the organic medium or the dispersant, the other ingredient or ingredients then being added and the mixture being agitated to provide the composition. The composition can also be made by grinding or milling the dry solid with the dispersant and then adding the liquid medium or mixing the solid with the dispersant in a liquid medium in a pigment flushing process.

The composition containing the plastic material may be prepared by any of the conventional methods known for preparing thermoplastic compounds. Thus, the solid, the thermoplastic polymer, and the dispersant may be mixed in any order, the mixture then being subjected to a mechanical treatment to reduce the particles of the solid to an appropriate size, for example, by Banbury mixing, ribbon blending, twin-screw extrusion, twin-roll milling, compounding in a Buss co-kneader, or similar equipment.

The composition of the present invention is particularly suited to liquid dispersions. In one embodiment, such dispersion compositions comprise:

(a) from 0.5 to 80 parts of a particulate solid;

(b) from 0.1 to 79.6 parts of a polymer of Formula I; and

(c) from 19.9 to 99.4 parts of an organic liquid and/or water; wherein all relative parts are by weight and the amounts (a)+(b)+(c)=100.

In one embodiment, component a) comprises from 0.5 to 30 parts of a pigment and such dispersions are useful as (liquid) inks, coatings (paints), and millbases.

If a composition is required comprising a particulate solid and a dispersant of Formula I in dry form, the organic liquid is typically volatile so that it may be readily removed from the particulate solid by a simple separation means such as evaporation. In one embodiment, the composition comprises the organic liquid.

If the dry composition consists essentially of the dispersant of Formula I and the particulate solid, it typically contains at least 0.2%, at least 0.5% or at least 1.0% dispersant of Formula I based on weight of the particulate solid. In one embodiment, the dry composition contains not greater than 100%, not greater than 50%, not greater than 20% or not greater than 10% by weight of dispersant of Formula I based on the weight of the particulate solid.

As disclosed hereinbefore, the compositions of the invention are suitable for preparing millbases wherein the particulate solid is milled in an organic liquid in the presence of a compound for Formula I.

Thus, according to a still further aspect of the invention, there is provided a millbase comprising a particulate solid, an organic liquid and a polymer of Formula I.

Typically, the millbase contains from 20 to 70% by weight particulate solid based on the total weight of the millbase. In one embodiment, the particulate solid is not less than 10 or not less than 20% by weight of the millbase. Such millbases may optionally contain a binder added either before or after milling.

In one embodiment, the binder is a polymeric material capable of binding the composition on volatilisation of the organic liquid.

Binders are polymeric materials including natural and synthetic materials. In one embodiment, binders include poly(meth)acrylates, polystyrenics, polyesters, polyurethanes, alkyds, polysaccharides such as cellulose, nitrocellulose, and natural proteins such as casein. The binder may be nitrocellulose. In one embodiment, the binder is present in the composition at more than 100% based on the amount of particulate solid, more than 200%, more than 300% or more than 400%.

The amount of optional binder in the millbase can vary over wide limits but is typically not less than 10%, and often not less than 20% by weight of the continuous/liquid phase of the millbase. In one embodiment, the amount of binder is not greater than 50% or not greater than 40% by weight of the continuous/liquid phase of the millbase.

The amount of dispersant in the millbase is dependent on the amount of particulate solid but is typically from 0.5 to 5% by weight of the millbase.

Dispersions and millbases made from the composition of the invention are particularly suitable for use in non-aqueous and solvent free formulations in which energy curable systems (ultra-violet, laser light, infra-red, cationic, electron beam, microwave) are employed with monomers, oligomers, etc. or a combination present in the formulation. They are particularly suitable for use in coatings such as paints, varnishes, inks, other coating materials and plastics. Suitable examples include their use in low, medium and high solids paints, general industrial paints including baking, two component and metal coating paints such as coil and can coatings, powder coatings, UV-curable coatings, wood varnishes; inks, such as flexographic, gravure, offset, lithographic, letterpress or relief, screen printing and printing inks for packaging printing, non impact inks such as inkjet inks including continuous inkjet and drop on demand inkjet which include thermal, piezo and electrostatic, phase change inks and hot melt wax inks, inks for ink jet printers and print varnishes such as overprint varnishes; polyol and plastisol dispersions; non-aqueous ceramic processes, especially tape-casting, gel-casting, doctor-blade, extrusion and injection molding type processes, a further example would be in the preparation of dry ceramic powders for isostatic pressing; composites such as sheet molding and bulk molding compounds, resin transfer molding, pultrusion, hand-lay-up and spray-lay-up processes, matched die molding; construction materials like casting resins, cosmetics, personal care like nail coatings, sunscreens, adhesives, toners such as liquid toners, plastics materials and electronic materials such as coating formulations for color filter systems in displays including organic light-emitting diode (OLED) devices, liquid crystal displays and electrophoretic displays, glass coatings including optical fibre coatings, reflective coatings or anti-reflective coatings, conductive and magnetic inks and coatings. They are useful in the surface modification of pigments and fillers to improve the dispersibility of dry powders used in the above applications. Further examples of coating materials are given in Bodo Muller, Ulrich Poth, Lackformulierung und Lackrezeptur, Lehrbuch fr Ausbildung und Praxis, Vincentz Verlag, Hanover (2003) and in P. G. Garrat, Strahlenhartung, Vincentz Verlag, Hanover (1996). Examples of printing ink formulations are given in E. W. Flick, Printing Ink and Overprint Varnish Formulations—Recent Developments, Noyes Publications, Park Ridge N.J., (1990) and subsequent editions.

Dispersions and millbases made from the composition of the invention are also useful for contact and non-contact (drop on demand) aqueous printing processes such as aqueous flexo, aqueous inkjet, aqueous UV inkjet.

In one embodiment, the composition of the invention further includes one or more additional known dispersants.

The following examples provide illustrations of the invention. These examples are non-exhaustive and are not intended to limit the scope of the invention.

### EXAMPLES

### Comparative Example 1 (CE1)—Polyether Amine Reacted with 1,2,4-Benzene Tricarboxylic Anhydride

A dispersant was prepared according to Example 1 in US Patent publication 2005/0120911 except Surfonamine® L207 replaces XJT-507. 1,2,4-Benzene tricarboxylic anhydride (14.4 parts) and polyether amine (150.0 parts, Surfonamine® L207, MW: 2000, ex Huntsman) were stirred at 120° C. for 1 hour and then 160° C. for 4 hours under a nitrogen atmosphere until no anhydride remained as determined by IR spectroscopy. The final product had an acid value of 27.4 mgKOH/g and imide peak at 1714.9 cm′.

### Example 1 (EX1)—Polyether Amine Reacted with 2-Carboxyethyl Acrylate then 1,2,4-Benzene Tricarboxylic Anhydride

Polyether amine (1023 parts, Surfonamine® L207, MW: 2000, ex Huntsman) and 3,5-di-tert-4-butylhydroxytoluene (0.8 parts) were stirred at 50° C. under air atmosphere. To this mixture, 2-carboxyethyl acrylate (73.66 parts) was added dropwise over 25 mins and held at 50° C. for 1 hour and then 80° C. for 3 hours until no vinyl peaks as determined by ¹H NMR spectroscopy. The temperature was then reduced to 55° C. after which 1,2,4-benzene tricarboxylic anhydride (98.12 parts) was added under a nitrogen atmosphere. The reaction mixture was stirred until the anhydride completely dissolved and then it was heated for a further 9 hours until no anhydride remained as determined by IR spectroscopy. The final product had an acid value of 77 mgKOH/g and the IR spectroscopy showed a tertiary amide carbonyl peak at 1638 cm⁻¹.

### Dispersion Test 1—Preparation of Titanium White Pigment Dispersion.

Dispersions were prepared by dissolving dispersants CE1 and EX1 (0.68 parts) into water (10.43 parts). To this was added defoamer (0.14 parts BYK® 024 ex BYK-Chemie, Altana Group), 3 mm glass beads (120 parts) and white pigment (33.75 parts Kronos® 2360 ex Kronos) and the contents were milled on a Scandex shaker for 1 hour. The resulting dispersion using EX1 produced a fluid millbase where as CE1 produced a gel.

Overall, the results indicate that the polymers of the invention provide at least one of improving increasing a particulate solid load, forming improved dispersions, having improved brightness, and producing a composition with reduced viscosity in an aqueous medium.

As described hereinafter, the number average molecular weight of the polymer of the present invention has been determined using known methods, such as Gel Permeation Chromatography (GPC) analysis using a polystyrene standard for all polymer chains.

### Comparative Example 2 (CE2)—Polyether Amine Reacted with 1,2,4-Benzene Tricarboxylic Anhydride

A dispersant was prepared according to Example 1 in US Patent publication 2005/0120911 except Surfonamine® L100 replaces XJT-507. 1,2,4-Benzene tricarboxylic anhydride (11.85 parts) and polyether amine (64.77 parts, Surfonamine® L100, MW: 1000, ex Huntsman) were stirred at 110° C. for 1 hour and then at 170° C. for 5 hours under the nitrogen atmosphere until no anhydride remained as determined by IR spectroscopy. The final product had acid value of 48.16 mgKOH/g and imide peak at 1713 cm⁻¹.

### Example 2 (EX-2)—Polyether Amine Reacted with Acrylic Acid then 1,2,4-Benzene Tricarboxylic Anhydride

Polyether amine (85.91 parts, Surfonamine® L207, MW: 2000, ex Huntsman) and Phenothiazine (0.026 parts) were stirred at 50° C. under air atmosphere. To this mixture, acrylic acid (3.07 parts) was added, the reaction temperature increased to 80° C. and the mixture was stirred for 5.5 hours until no vinyl peaks were present as determined by 1H NMR spectroscopy. The temperature was then reduced to 50° C. after which 1,2,4-benzene tricarboxylic anhydride (8.19 parts) was added under the nitrogen atmosphere. The reaction mixture was stirred for 24 hours until anhydride was dissolved, and no anhydride peaks remained as determined by IR spectroscopy. The final product had an acid value of 74.40 mgKOH/g and the IR spectroscopy showed a tertiary amide carbonyl peak at 1637 cm′.

### Example 3 (Ex3)—Polyether Amine Reacted with 2-Carboxyethyl Acrylate then 1,2,4-Benzene Tricarboxylic Anhydride

Polyether amine (212.93 parts, Surfonamine® L100, MW: 1000, ex Huntsman) and 3,5-di-tert-4-butylhydroxytoluene (0.84 parts) were stirred at 50° C. under air atmosphere. To this mixture, 2-carboxyethyl acrylate (28.85 parts) was added dropwise over 50 minutes and left at 50° C. over 30 minutes and then at 80° C. for 3 hours until no vinyl peaks were present as determined by ¹H NMR spectroscopy. The temperature was then reduced to 50° C. after which 1,2,4-benzene tricarboxylic anhydride (39.11 parts) was added under the nitrogen atmosphere. The reaction mixture was stirred until the anhydride completely dissolved and then it was heated for further 10 hours until no anhydride peaks remained as determined by IR spectroscopy. The final product had an acid value of 117.71 mgKOH/g and the IR spectroscopy showed a tertiary amide carbonyl peak at 1633 cm′.

### Example 4 (Ex4)—Polyether Amine Reacted with 1,2-Epoxy-3-Phenoxypropane then 1,2,4-Benzene Tricarboxylic Anhydride

Polyether amine (101.64 parts, Surfonamine® L100, MW: 1000, ex Huntsman) and 3,5-di-tert-4-butylhydroxytoluene (0.36 parts) were stirred at 50° C. under air atmosphere. To this mixture, 1,2-epoxy-3-phenoxypropane (15.17 parts) was added dropwise over 10 minutes and left stirring at 50° C. for 30 minutes. Reaction mixture was stirred at 50° C. for further 18 hours until no epoxide peaks were present as determined by IR or ¹H NMR spectroscopy. Upon this time 1,2,4-benzene tricarboxylic anhydride (19.47 parts) was added under the nitrogen atmosphere. The reaction mixture was stirred until the anhydride completely dissolved and then for further 10 hours until no anhydride remained as determined by IR spectroscopy. The final product had an acid value of 81.79 mgKOH/g and the IR spectroscopy showed a tertiary amide carbonyl peak at 1665 cm′.

### Dispersion Test 2—Preparation of Titanium White Pigment Dispersion in Water

Dispersions were prepared by dissolving dispersants comparative examples (CE-1 and CE-2) and examples (EX1-4) (0.15 parts) into water (3.32 parts). To this was added (0.03 parts BYK® 024 ex BYK-Chemie, Altana Group), 3 mm glass beads (17 parts) and white pigment (6.50 parts Kronos® 2360, ex Kronos) and the contents were milled on a horizontal shaker for 16 hours. The resulting dispersion was then assessed for fluidity.

TABLE 1
Pigment dispersion results from Dispersion test 2

| | | Comparative | |
|---|---|---|---|
| Dispersant | Fluidity | example | Fluidity |
| Example 1 | Very fluid | Comparative | Very viscous |
| (EX-1) | liquid | example 1 | liquid |
| Example 2 | Very fluid | (CE-1) | |
| (EX-2) | liquid | | |
| Example 3 | Very fluid | Comparative | Very viscous |
| (EX-3) | liquid | example 2 | liquid |
| Example 4 | Very fluid | (CE-2) | |
| (EX-4) | liquid | | |

### Dispersion Test 3—Preparation of Titanium White Pigment Dispersion in 1-Methoxy-2-Propyl Acetate.

Dispersions were prepared by dissolving dispersants comparative examples (CE-1 and CE-2) and examples (EX1-3) (0.15 parts) into 1-methoxy-2-propyl acetate (2.35 parts). To this was added 3 mm glass beads (17 parts), white pigment (7.50 parts Kronos® 2360, ex Kronos) and the contents were milled on a horizontal shaker for 16 hours. The particle sizes (D50 and D90) of the resulting dispersions were determined by a Microtrac DLS Nano-flex particle size analyser.

TABLE 2
Pigment dispersion results from Dispersion test 3

| Dispersant | D50/nm | D90/nm |
|---|---|---|
| Example 1 (EX-1) | 232.9 | 301.0 |
| Example 2 (EX-2) | 228.9 | 316.0 |
| Comparative example 1 (CE-1) | 522.0 | 669.0 |
| Example 3 (EX-3) | 235.2 | 280.1 |
| Comparative example 2 (CE-2) | 845.0 | 1206.0 |

Each of the documents referred to above is incorporated herein by reference. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A dispersant or its salts comprising a dispersant polymer having the following structure: 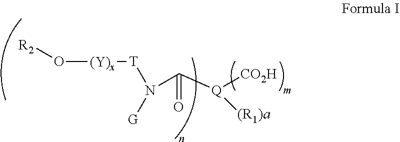
R₁ is independently CO₂H or SO₃H where a is 1 to 2 or 3;
R₂ is H, a C₁₋₅₀ optionally substituted hydrocarbyl, or C₁₋₅₀ optionally substituted hydrocarbonyl group;
wherein T is —C(O)—CH(R₄)CH₂ or C₁₋₅ hydrocarbyl chain;
when G is C₁₋₅₀ hydrocarbyl, T is —C(O)—CH(R₄)CH₂,
when G is residue of acrylate reacted with a nitrogen in a Michael Addition reaction or epoxide opened by a ring opening epoxy polymerization, T is C₁₋₅ hydrocarbyl chain;
R₄ is H or Me;
G is a C₁₋₅₀ hydrocarbyl group optionally substituted with heteroatoms such as O or N represented as ether, ester, aldehyde, ketone, amide, urethane, alcohol or carboxylic acid groups, or the residue of an optionally substituted alkyl (meth)acrylate or (meth)acrylamide, or the ring opening product of an epoxide of the formula 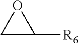
wherein R₆ individually on each occurrence is H or CH₃ or C₂H₅ or one of the following groups: 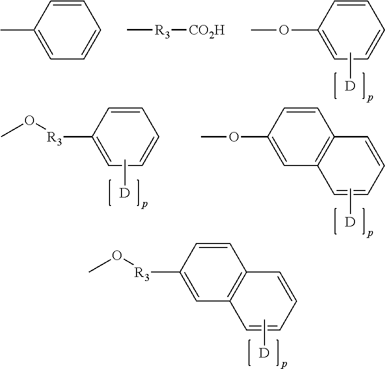
wherein D is C₁₋₅ alkyl group, CN, OH, NO₂, NH₂, halogen, CO₂H, SO₃H, CH₃ or OCH₃; p is from 0 to 4;
R₃ is a linear or branched C₁₋₅₀;
Y independently in each repeat unit is C₂₋₄ alkyleneoxy;
Q is a hydrocarbylene group comprising one or more aromatic ring, optionally substituted with R₁, (up to three or four rings), optionally being fused if two aromatic rings are present, wherein carboxylic acid group attached to Q are attached to a carbon atom of the aromatic ring of Q;
wherein the hydrogen of any acid in the formula is optionally replaced by a metal, amine, or ammonium cation to place the dispersant in the form of a salt; and
x is 2 to 90.

2. The dispersant of claim 1, wherein Q comprises a naphthalene.

3. The dispersant of claim 1, wherein Q comprises biphenyl.

4. The dispersant of claim 1, wherein Q comprises a phenyl.

5. The dispersant of claim 1, wherein the dispersant is obtained by a process comprising:
Step (1): reacting a Michael acceptor with a nitrogen atom of a nucleophilic polymeric chain forming a polyether functionalized secondary amine; 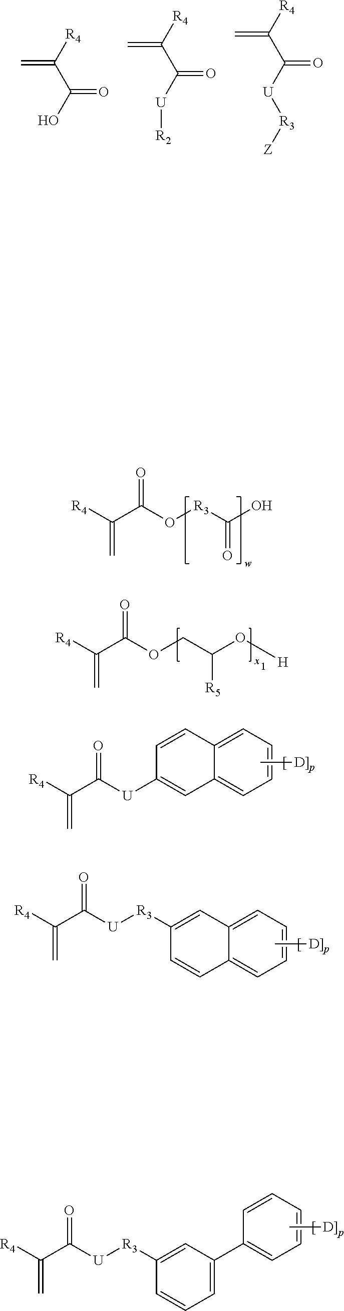
and
Step (2): reacting said polyether functionalized secondary amine with an acid functionalized aromatic di-acid or anhydride thereof, to form the tertiary amide connecting group between said aromatic acid and said polyether.

6. The dispersant of claim 5, wherein said Step (1) is conducted at a temperature from about 0° C. to 150° C., and said Step (2) is carried out at a temperature from about 50° C. to 120° C.

7. The dispersant claim 1, wherein the dispersant is obtained by a process comprising:
Step (1): reacting a (meth)acrylate or functionalized (meth)acrylate monomer having an unsaturated acrylate functionality, with a nucleophilic aliphatic amine, forming a MPEG functionalized secondary amine; and
Step (2): reacting said MPEG functionalized secondary amine with an acid functionalized aromatic di-acid or anhydride thereof, to form the tertiary amide linkage from one of the acid groups of said diacid or anhydride thereof, connecting said MPEG to said aromatic di-acid now an acid/amide; wherein said Step (1) is carried out at a temperature from about 0° C. to 150° C.; wherein said Step (2) is carried out at a temperature of from about 0° C. to 120° C., and more desirably from about 30° C. to 80° C.

8. The dispersant of claim 1, wherein the dispersant is obtained by a process comprising:
Step (1): reacting a hydroxyl acrylate, with a nucleophilic aliphatic amine forming an aliphatic secondary amine;
Step (2): reacting said aliphatic secondary amine with an acid functionalized aromatic di-acid or tetra-acid or anhydride thereof, forming the tertiary amide; and
Step (3): optionally reacting said hydroxyl of said aliphatic secondary amide with an epoxide or cyclic ester, wherein said cyclic ester is optionally caprolactone, and/or polymerising said epoxide or cyclic ester to form the polymeric polyether chain or polyester chain, wherein said Step (1) is carried out at a temperature from about 0° C. to 150° C.; wherein said Step (2) is carried out from a temperature from about 50° C. to 120° C.; and wherein said Step (3), if performed, is carried out at a temperature from about 100° C. to 200° C.

9. The dispersant of claim 1, wherein said dispersant is according to at least one of the following: 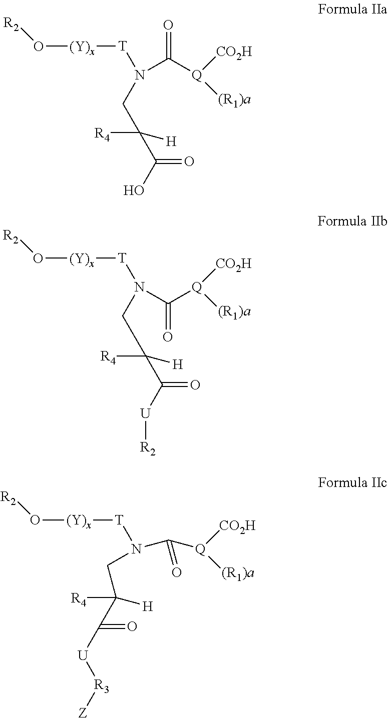
wherein the variables in Formulae IIa to IIc are as defined in claim 1, the hydrogen of any acid in the formula is optionally replaced by a metal, amine, or ammonium cation to place the dispersant in the form of a salt and wherein U is O or NH and Z is —OH, —N(R₇)₂ (where R₇ individually at is occurrence is a C₁₋₅ alkyl group), C₃₋₆ cycloalkyl group, a 5, 6 or 7 atom heterocycle of carbon and oxygen and/or nitrogen; or acid group such as CO₂H, SO₃H, OPO₃H₂.

10. The dispersant of claim 1, wherein said dispersant is according to at least one of the following: 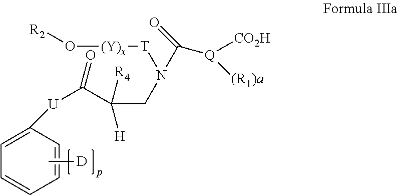
wherein the variables in Formula IIIa are as defined in claim 1, D is C₁₋₅ alkyl group, CN, OH, NO₂, NH₂, halogen, CO₂H, SO₃H, CH₃ or OCH₃, and p is from 0 to 4; 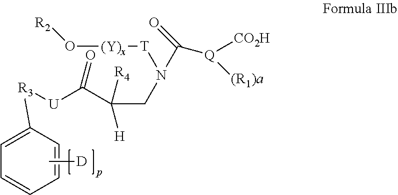
wherein the variables in Formula IIIb are as defined in claim 1, the hydrogen of any acid in the formula is optionally replaced by a metal, amine, or ammonium cation to place the dispersant in the form of a salt and wherein U is O or NH.

11. The dispersant of claim 1, wherein said dispersant is according to at least one of the following: 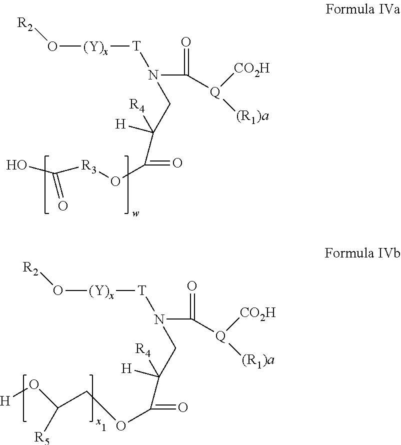
wherein the variables in Formulae IVa to IVb are as defined in claim 1, the hydrogen of any acid in the formula is optionally replaced by a metal, amine, or ammonium cation to place the dispersant in the form of a salt and wherein xi is from 1 to 20.

12. The dispersant of claim 1, wherein said dispersant is according to: 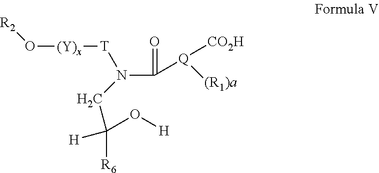
where the variables in Formula V are as defined in claim 1, R₆ individually on each occurrence is H, CH₃ or C₂H₅ or one of the following groups: 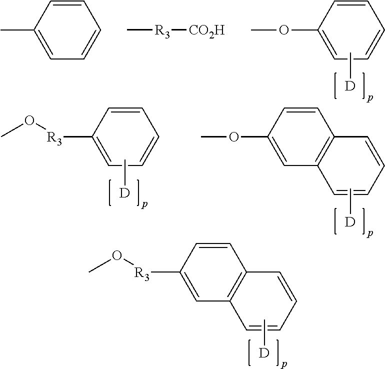
wherein D is C₁₋₅ alkyl group, CN, OH, NO₂, NH₂, halogen, CO₂H, SO₃H, CH₃ or OCH₃ and p is from 0 to 4; and
wherein the hydrogen of any acid in the formula is optionally replaced by a metal, amine, or ammonium cation to place the dispersant in the form of a salt.

13. A composition comprising a particulate solid, an aqueous medium or a polar organic solvent medium, and a dispersant according to claim 1.

14. The composition of claim 13, wherein the medium comprises an aqueous medium.

15. The composition of claim 13, wherein the medium comprises a polar organic medium.

16. The composition of claim 13, wherein the composition is a millbase, paint or ink.

17. The composition of claim 13, wherein the particulate solid is a pigment or a filler.

18. The composition of claim 13, further comprising a binder.

19. The composition of claim 13, wherein the dispersant is present in an amount ranging from 0.1 wt % to 79.6 wt %.

20. The composition of claim 13, wherein the dispersant is present in an amount ranging from 0.5 wt % to 30 wt %, based on the total composition weight.
